(19) United States
(12) Patent Application Publication
(10) Pub. No.: US 2024/0083515 A1
(43) Pub. Date: Mar. 14, 2024

(54) HYBRID ELECTRIC VEHICLES WITH A REINFORCING DEVICE CONNECTED TO THE FRONT SIDE MEMBER

(71) Applicant: PSA AUTOMOBILES SA, Poissy (FR)

(72) Inventors: Marc PERU, Chatenay Malabry (FR); Stephane FONFREDE, Belfort (FR); Alain VALTIER, Autouillet (FR); Damien BOSSUAT, Maurepas (FR); Richard ZEITOUNI, Bois D Arcy (FR)

(21) Appl. No.: 18/263,489

(22) PCT Filed: Jan. 14, 2022
(86) PCT No.: PCT/FR2022/050086

§ 371 Date: Jul. 28, 2023

(30) Foreign Application Priority Data
Feb. 10, 2021 (FR) 2101268

(51) Int. Cl. B62D 25/20

(52) U.S. Cl. CPC B62D 25/2018

(57) ABSTRACT

The invention relates to a hybrid electric vehicle comprising a floor pan (1) with a central tunnel (3), at least two longitudinal girders (5), an underframe (7) extending under the floor pan and transversally between the at least two girders (5), and at least two side members (9, 11, 13) extending under the floor pan in the direction of the underframe (7), including at least two front side members (9) arranged on either side of the central tunnel (3), the vehicle being characterized in that it further comprises one or more reinforcing devices (15, 17), said devices being elongate bodies having two ends with one of said ends being attached to a side member (9, 11, 13), and in that the one or more reinforcing devices (15, 17) are attached under the floor pan (1) of the vehicle and are arranged to extend in a direction that forms an angle with the longitudinal direction of the vehicle.

### CROSS-REFERENCE TO RELATED APPLICATIONS

This application is the US National Stage under 35 USC § 371 of International Application No. PCT/FR2022/050086, filed Jan. 14, 2022, which claims the priority of French application 2101268 filed on Feb. 10, 2021, the content (text, drawings and claims) of both said applications being is incorporated by reference herein.

### BACKGROUND

The devices described herein relate to the field of hybrid electric motor vehicles.

Hybrid-type motor vehicles comprise an internal combustion engine in addition to an electric motor. The two motors operate simultaneously or alternately so as to reduce the total power consumed by the vehicle. The battery of the electric motor is generally of parallelepiped shape, and is either implanted under the floor pan of the vehicle, at the front seat crossmember, or housed in the rear part of the vehicle, in the trunk or under the body.

In the case of an implantation under the floor pan of the vehicle, the battery generally has a limited size and a mass generally less than 150 kg. This configuration is that of hybrid vehicles having reduced range. This is referred to as MHEV-type motorization (Mild Hybrid Electric Vehicle). These hybrid vehicles have a battery which makes it possible to assist the thermal engine.

In the case of being housed in the rear part of the vehicle, it is possible to install bulkier batteries which therefore have a mass greater than 150 kg, or even greater than 250 kg. This type of hybrid vehicles has a greater range than MHEV-type vehicles, since the battery is a rechargeable battery that can be recharged from an external power source. This is referred to as a PHEV-type motorization (Plug-in Hybrid Electric Vehicle).

When the battery is installed under the floor pan, it must for example straddle the sub-floor front side members, which limits the size of the batteries that can be implanted. One solution to increase the size of the sub-floor batteries of a vehicle is not to straddle the sub-floor side members but to intersect them. However, in the event of a frontal impact, the force transmission relay is then taken up by the shell of the battery or by protective frames designed and arranged for this purpose. Nevertheless, intersecting the sub-floor side members presents the risk of degrading the strength of the underframe during frontal impacts, in particular by increasing the probability of shearing of the floor pan.

Furthermore, in the event of a violent crash, there is a significant risk of the side members backing up until they come into contact with the protective shells of the batteries or “battery tray”, which is not desirable in view of the risks associated with damage to the batteries following a piercing of said battery tray.

When the battery is housed in the rear part of the vehicle, this makes it possible to considerably increase the mass of the battery and therefore its power. However, in the event of a frontal impact, the force transmission relay is generally taken up by the underframe which is placed under the floor pan in front of the battery. Depending on the severity of the crash, the floor pan can also shear, since the battery, due to its significant mass, will push and crush the floor pan.

In order to reinforce the floor pan, document DE 102014006718 describes the presence of a reinforcing structure arranged transversally between the tunnel and the side members and extending longitudinally from a rear part of the tunnel to a front part of the girders. This reinforcing structure makes it possible to obtain a floor pan having a certain resistance during a frontal impact with a small width overlap. This particular configuration makes it possible in particular to avoid the intrusion of the front wheels into the passenger compartment of the vehicle during an offset frontal impact.

Nevertheless, while a battery can be nested within the described reinforcing structure, the movement of the sub-floor side members during a frontal impact is not taken into account and such a structure does not solve the problem in the case where this battery is housed in the rear zone of the vehicle.

### SUMMARY

The devices described herein aim to improve the prior situation. In particular, described herein is a means for dissipating the energy introduced by a frontal impact on the side members so as to reduce or avoid the shearing of the floor pan of a hybrid electric vehicle.

To this end, a first aspect relates to a hybrid electric motor vehicle comprising a floor pan with a central tunnel, at least two longitudinal girders arranged respectively at each lateral edge of the floor pan, an underframe extending under the floor pan and transversally between the at least two girders, at least two side members extending under the floor pan in the direction of said underframe, including at least two side members arranged on either side of the central tunnel, said vehicle being characterized in that it further comprises one or more reinforcing devices, selected from at least one bypass device and/or at least one anchoring device, in that said one or more reinforcing devices are elongate bodies having two ends defining a front end and a rear end, with one of said ends being attached to a side member, and in that the one or more reinforcing devices are attached under the floor pan of the vehicle and are arranged to extend in a direction that forms an angle with the longitudinal direction of the vehicle.

As will be understood from reading the definition that has just been given, described herein is the creation of at least one additional load path in order to lighten the force experienced by the one or more side members in the event of a frontal impact. The energy received during the impact is dissipated via the one or more reinforcing devices and is no longer directed directly toward the rear of the vehicle on the underframe. By adding reinforcing devices, the path that forces follow is extended, allowing the dissipation of energy and therefore lightening the loads on the underframe and also avoiding the shearing of the floor pan, within the limit of the violence of the frontal impact.

According to a first embodiment, the vehicle further comprises at least one external sub-floor side member extending parallel to a front side member and arranged between said front side member and a girder, and comprises at least one bypass device attached to an external side member by one of its ends. Preferably, at least one bypass device is attached to the external side member by its front end. Preferably, at least one bypass device is attached to the front side member by its rear end.

Preferably, the vehicle further comprises a battery implanted under the floor pan, and at least one front side member or one external side member is an intersected side member; an intersected side member comprising two parts defining a front part and a rear part between which the battery is arranged, the rear part comprising a rear end attached to the underframe, and at least one bypass device is attached to the rear part of an intersected side member. For example, at least one intersected side member is a front side member.

Advantageously, the vehicle comprises at least one mixed reinforcing device comprising a bypass device and an anchoring device placed end-to-end so as to form a single part, the mixed one or more reinforcing devices being attached to an external side member by their front end and to the underframe by their rear end. Preferably, at least one mixed reinforcing device is configured to straddle a front side member and attached thereto.

According to a second embodiment, alternative to the first embodiment, the vehicle comprises a battery housed behind the underframe and at least two anchoring devices are attached to a single front side member.

Regardless of the embodiment selected, the following features advantageously define the one or more reinforcing devices:

Preferably, at least one reinforcing device is a hollow body.

Preferably, at least one reinforcing device has a height of less than 30 mm, or less than 25 mm, or less than 20 mm.

Preferably, the one or more reinforcing devices are steel parts; for example, steel parts having a tensile strength of between 400 and 1200 MPa as determined by standard ISO 6892-1, or between 500 and 1100 MPa, or between 600 and 1000 MPa.

Preferably, the one or more reinforcing devices are U-shaped profile members and at least one of the ends of said profile members has an elbow.

Also, regardless of the embodiment selected, the vehicle preferably comprises at least one anchoring device attached to a front side member by its front end and to the underframe by its rear end. For example, at least two anchoring devices are attached to a single front side member.

Also, regardless of the selected embodiment, the vehicle comprises at least one anchoring device attached to a front side member by its front end and to the underframe by its rear end, the rear end being contiguous with a girder and/or the vehicle further comprises an internal sub-floor side member extending parallel to a front side member and arranged between said front side member and the central tunnel, and the vehicle comprises at least one anchoring device attached to a front side member by its front end and to the underframe by its rear end, the rear end being contiguous with said internal side member.

Also, regardless of the embodiment selected, the vehicle comprises for example a rear seat crossmember arranged on the floor pan, one of said ends of the one or more reinforcing devices is attached to a front side member below the rear seat crossmember.

### BRIEF DESCRIPTION OF THE FIGURES

The disclosed devices will be well understood and other aspects and advantages will become clear from reading the following description is given with reference to the appended drawings.

FIG. 1 is a bottom view of the floor pan of an MHEV-type hybrid electric motor vehicle.

FIG. 2 is a bottom view of the floor pan of a PHEV-type hybrid electric motor vehicle.

FIG. 3 shows a reinforcing device.

### DETAILED DESCRIPTION

In the remainder of the description, the term “comprise” is synonymous with “include” and is not limiting in that it allows the presence of other elements in the vehicle to which it refers. It is understood that the term “comprise” includes the term “consist of”.

Likewise, the terms “lower”, “upper”, “top” and “bottom” will be understood according to their usual definition, in which the terms “lower” and “bottom” indicate greater proximity to the ground in the vertical direction than the terms “upper” and “top”, respectively.

The terms “longitudinal”, “transverse”, “front” and “rear” will be understood relative to the general orientation of the vehicle as taken in its normal driving direction.

In the various figures, the same references designate identical or similar elements.

During a frontal impact, the sub-floor side members of a vehicle transmit the energy towards the rear of said vehicle. In the case of a hybrid electric vehicle, where the protection of the battery is a necessary condition for the safety of the occupants, it is necessary to ensure that the energy is dissipated in order, within the limit of the violence of the frontal impact, to maintain the integrity of the floor pan, which makes it possible not to impact the actual battery during the crash. Thus, by attaching to the side members one or more sub-floor reinforcing devices and by arranging them to extend in a direction that forms an angle with the longitudinal direction of the vehicle, it becomes possible to dissipate the energy towards the rear of said vehicle. The shearing of the floor pan is then reduced, or even eliminated because the deformation of the structural elements of the vehicle is contained.

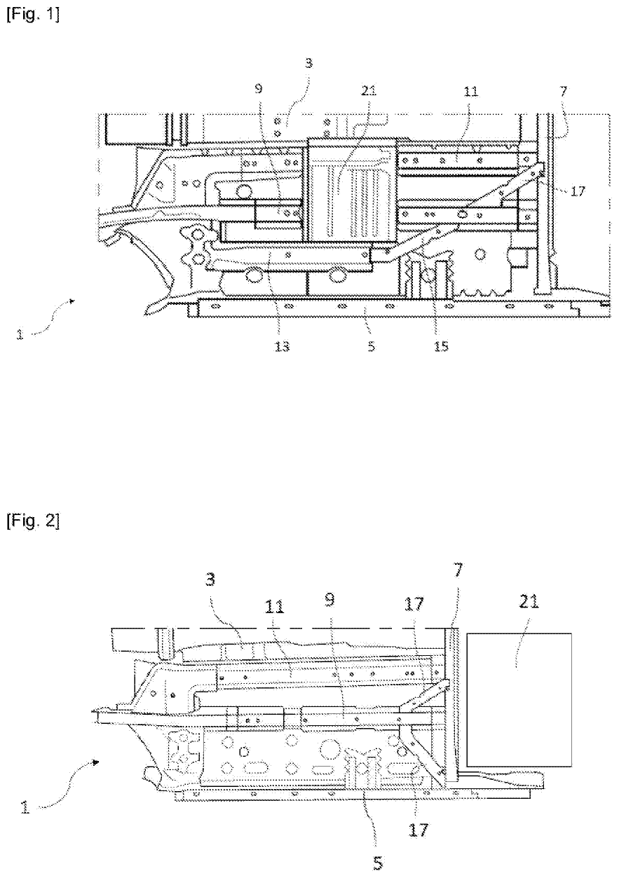

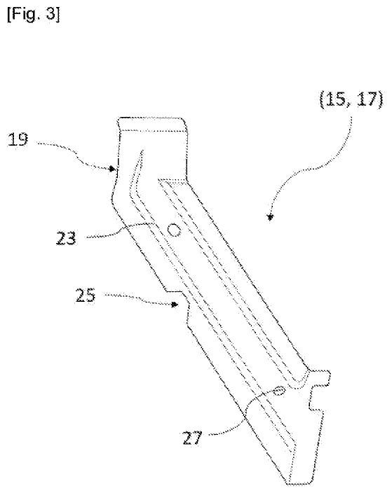

The devices disclosed herein therefore relate to a hybrid electric vehicle, the floor pan 1 of which is shown below in FIGS. 1 and 2. The floor pan 1 therefore comprises a central tunnel 3, at least two girders 5 arranged respectively at each lateral edge of the floor pan 1, an underframe 7 extending under the floor pan and transversally between said at least two girders 5 (only one is depicted in each of FIGS. 1 and 2), at least two side members (9, 11, 13) extending under the floor pan in the direction of said underframe 7, including at least two front side members 9 arranged on either side of the central tunnel 3 (only one is depicted in each of FIGS. 1 and 2). The vehicle further comprises one or more reinforcing devices (15, 17) selected from at least one bypass device 15 and/or at least one anchoring device 17, the one or more reinforcing devices (15, 17) being elongate bodies having two ends defining a front end and a rear end, one of said ends being attached to a side member (9, 11, 13). In addition, the one or more reinforcing devices (15, 17) are attached under the floor pan 1 of the vehicle and are arranged to extend in a direction that forms an angle with the longitudinal direction of the vehicle.

For example, at least one reinforcing device is a hollow body.

The one or more reinforcing devices have for example a height less than 30 mm, or less than 25 mm, or less than 20 mm. This distance makes it possible to maintain sufficient floor clearance for the vehicle floor pan.

The one or more reinforcing devices are advantageously steel parts;

for example, steel parts having a tensile strength of between 400 and 1200 MPa as determined by ISO 6892-1, or between 450 and 1150 MPa, or between 500 and 1100 MPa, or between 550 and 1050 MPa, or between 600 and 1000 MPa. The one or more reinforcing devices are for example attached to the floor pan, to one of the side members and/or to the underframe by welding, preferably by means of electric spot welding.

The one or more reinforcing devices are advantageously U-shaped profile members and at least one of the ends of said profile members has an elbow 19, visible in FIG. 3, allowing it to be placed on the lateral faces of the side members and/or on the lateral face of the underframe, in particular the lateral face turned towards the front of the vehicle. The one or more reinforcing devices are then attached to one of the side members and/or the underframe at the elbow 19 by welding, in particular by means of electric spot welding. It is nevertheless possible to attach them by any means, for example by screwing.

FIG. 3 also makes it possible to view the presence of at least one reinforcement relief 23 arranged in the main direction of the one or more reinforcing devices. The presence of this relief contributes to guaranteeing adequate stiffness of the one or more reinforcing devices.

As the one or more reinforcing devices are attached under the floor pan, the one or more devices can be brought to be superimposed on the cables and/or to be superimposed on moldings of the floor pan. Under such circumstances, at least one of the edges of the one or more reinforcing devices may have at least one notch 25 intended for passing the cable or cables and/or the molding or moldings of the floor pan.

Finally, the one or more reinforcing devices may have one or more holes 27, which are used during the cataphoresis process in order to eliminate the excess paint.

Among the reinforcing devices, the bypass device is arranged so as to prevent force from being directed directly against a particular element of the vehicle, for example a battery or the underframe. The bypass device may also serve to redirect the force experienced by the vehicle onto another structural element of the vehicle.

The anchoring device on the other hand is arranged so as to prevent structural elements, such as the underframe, from deforming during impact to the point of causing the shearing of the floor pan. It is arranged so as to distribute force at different locations of the structural element.

The one or more reinforcing devices are arranged to extend in a direction that forms an angle with the longitudinal direction of the vehicle. For example, this angle may comprise between 20° and 70°, or between 30° and 60°, or between 35° and 55°.

Advantageously, it is useful for the vehicle to comprise at least one anchoring device 17 attached to the front side member 9 by its front end and to the underframe 7 by its rear end. Indeed, during a frontal impact, a side member being connected to the underframe is likely to transmit force onto same. The presence of an anchoring device 17 attached by one end to the front side member and by the other end to the underframe creates an additional location on the underframe 7 to which force can be transmitted, which lightens the loads on the underframe because the energy induced in the vehicle structure dissipates at least partially.

More preferentially, the vehicle comprises at least two anchoring devices 17 attached to a single front side member 9. This makes it possible to obtain three locations on the underframe to which the force can be transmitted in the event of a frontal impact.

For example, the vehicle comprises at least one anchoring device 17 attached to a front side member 9 by its front end and to the underframe 7 by its rear end, the rear end being contiguous with a girder 5. The fact of moving the location at which the anchoring device is attached to the underframe away from the location at which the front side member is attached to the underframe makes it possible to further optimize the dissipation of the energy induced during the frontal impact and to further reduce the loads on the underframe.

For example, the vehicle comprises an internal sub-floor side member 11 which extends parallel to a front side member 9 and which is arranged between said front side member 9 and the central tunnel 3. In this case, the vehicle may comprise at least one anchoring device 17 attached to a front side member 9 by its front end and to the underframe 7 by its rear end, the rear end being contiguous with said internal side member 11.

It is preferable to attach the one or more reinforcing devices to the side members, for example to the front side member 9, at a location that is located below (that is to say vertical with) the rear crossmember of the vehicle, which is arranged on the floor pan.

According to a first embodiment, illustrated in FIG. 1, the hybrid electric vehicle is of the MHEV type. This vehicle comprises at least one external sub-floor side member 13 which extends parallel to a front side member 9 and which is arranged between said front side member 9 and a girder 5. The vehicle comprises at least one bypass device 15 attached to a front side member 9 by one of its ends and to an external side member 13 by its other end.

The bypass one or more devices 15 therefore offer an additional load path so that the force experienced by the external side members is not directed directly onto the underframe 7.

For example, the MHEV-type vehicle comprises a battery 21 implanted under the floor pan, which implies that at least one of the front 9 or external 13 side members is an intersected side member, preferably the front side member 9. For example, the battery 21 can be implanted under the floor pan below the front seat crossmember. The intersected side member comprises two parts that define a front part and a rear part between which the battery 21 is arranged, the rear part comprising a rear end attached to the underframe 7. Advantageously, at least one bypass device 15 is attached to the rear part of a intersected side member and the energy induced during the frontal impact, within the limit of the violence of the impact, will then bypass the battery and no longer cause the intrusion of the side member or side members into said battery. Preferably, said at least one bypass device 15 is attached to the external side member 13 by its front end.

When the MHEV-type hybrid electric vehicle advantageously comprises at least one anchoring device, it is possible to associate the bypass device 15 and an anchoring device 17. The two devices are placed end to end and can therefore be attached by welding, for example via the formation of electrical welding spots. A mixed reinforcing device is then obtained, comprising the two devices placed end-to-end. The mixed reinforcing device is attached to the external side member by its front end and to the underframe by its rear end.

Advantageously, it may be economical for the mixed reinforcing device to be a single part. This makes it possible to simplify the mounting of these devices on the vehicle. Preferably, the mixed reinforcing device is configured to straddle a front side member and to be attached thereto.

According to a second embodiment, illustrated in FIG. 2, the hybrid electric vehicle is of the PHEV type. This vehicle comprises a battery 21 housed behind the underframe 7 and at least two anchoring devices 17 are attached to a single front side member 9.

During a frontal impact, the energy induced in the vehicle will therefore be dispersed in three different locations on the underframe, making it possible to lighten the load thereon and to reduce, or even eliminate, the shearing of the floor pan.

1. A hybrid electric motor vehicle comprising a floor pan with a central tunnel, at least two longitudinal girders arranged respectively at each lateral edge of the floor pan, an underframe extending under the floor pan and transversally between the at least two girders, at least two side members extending under the floor pan in the direction of said underframe, including at least two front side members arranged on either side of the central tunnel, wherein said vehicle further comprises one or more reinforcing devices, selected from at least one bypass device and/or at least one anchoring device, wherein said one or more reinforcing devices are elongate bodies having two ends defining a front end and a rear end, with one of said ends being attached to a side member, and wherein the one or more reinforcing devices are attached under the floor pan of the vehicle and are arranged to extend in a direction that forms an angle with the longitudinal direction of the vehicle.

2. The vehicle according to claim 1, wherein at least one reinforcing device is a hollow body.

3. The vehicle according to claim 1, comprising at least one anchoring device attached to a front side member by its front end and to the underframe by its rear end.

4. The vehicle according to claim 1, wherein the vehicle comprises:
a) at least one anchoring device attached to a front side member by its front end and to the underframe by its rear end, the rear end being contiguous with one of the at least two girders; and/or
b) an internal sub-floor side member extending parallel to a front side member and arranged between said front side member and the central tunnel,
further wherein the vehicle comprises at least one anchoring device attached to a front side member via its front end and to the underframe by its rear end, the rear end being contiguous with said internal side member.

5. The vehicle according to claim 1, wherein the vehicle comprises a rear seat crossmember arranged on the floor pan, one of said ends of the one or more reinforcing devices is attached to a front side member below the rear seat crossmember, and/or the one or more reinforcing devices are U-shaped profiles and at least one of the ends of said profiles has an elbow.

6. The vehicle according to claim 1, wherein the one or more reinforcing devices are steel parts.

7. The vehicle according to claim 1, further comprising at least one external sub-floor side member extending parallel to a front side member and arranged between said front side member and one of the at least two girders, and at least one bypass device attached to an external side member by one of its ends.

8. The vehicle according to claim 7, further comprising a battery implanted under the floor pan, wherein at least one front side member or an external side member is an intersected side member; said intersected side member comprising two parts defining a front part and a rear part between which the battery is arranged, the rear part comprising a rear end attached to the underframe, and wherein at least one bypass device is attached to the rear part of an intersected side member.

9. The vehicle according to claim 7, comprising at least one mixed reinforcing device comprising a bypass device and an anchoring device placed end-to-end so as to form a single part, the mixed one or more reinforcing devices being attached to an external side member by their front end and to the underframe by their rear end.

10. The vehicle according to claim 1, comprising a battery housed behind the underframe and wherein at least two anchoring devices are attached to a single front side member.

11. The vehicle according to claim 2 wherein said least one reinforcing device has a height of less than 30 mm.

12. The vehicle according to claim 3 wherein at least two anchoring devices are attached to a single front side member.

13. The vehicle according to claim 6 wherein said steel parts have a tensile strength of between 400 and 1200 MPa as determined by standard ISO 6892-1.

14. The vehicle according to claim 7 wherein said at least one bypass device is attached to the external side member by its front end.

15. The vehicle according to claim 8 wherein said at least one intersected side member is a front side member.

16. The vehicle according to claim 9 wherein said at least one mixed reinforcing device is configured to straddle a front side member and to attach to said side front member.
